(19) United States
(12) Patent Application Publication
(10) Pub. No.: US 2023/0237493 A1
(43) Pub. Date: Jul. 27, 2023

(54) GRAPH-BASED ANALYSIS FRAMEWORK

(71) Applicant: PAYPAL, INC., San Jose, CA (US)

(72) Inventors: Jun Gu, Shanghai (CN); Sheng Liu, Shangahi (CN); Qiwen Yin, Shangahi (CN)

(21) Appl. No.: 17/584,958

(22) Filed: Jan. 26, 2022

(51) Int. Cl. G06Q 20/40; G06F 16/901

(52) U.S. Cl. CPC G06Q 20/4016; G06F 16/9024; G06N 20/00

(57) ABSTRACT

Methods and systems are presented for improved detection of fraudulent activity within a payment system. Methods and/or systems receive one or more seed accounts from among a plurality of accounts, generate a graph based on the one or more seed accounts where the graph includes a plurality of nodes including one or more first nodes corresponding to the one or more seed accounts and a plurality of second nodes corresponding to a plurality of accounts that are associated with the one or more seed accounts, link the related nodes within the graph based on a common attribute shared between a pair of corresponding accounts, identify one or more groups within the one or more communities based at least on a density of connections among the nodes within the one or more communities, and determine, using a machine learning model, a corresponding label for each group in the one or more groups.

### BACKGROUND

The present specification generally relates to a graph-based user interface, and more specifically, to providing an interactive user interface for illustrating mass transactions in a graph data structure according to some embodiments of the disclosure.

### RELATED ART

Detecting fraudulent activity within a payment system is considered good business practice and is required within the banking industry. For example, there are laws that require banks to implement “know your customer” and customer verification procedures to prevent money laundering. While computer-based tools have been used for detecting fraudulent activities, many existing tools rely mainly on hard-coded rules to analyze each account individually. As those committing fraud become more sophisticated in methods of committing fraud (e.g., multiple accounts may collude to collectively commit fraudulent activities, etc.), the existing computer-based tools may not be able to effectively detect fraudulent activities due to their limitations. When these systems fall short, an investigator may be able to identify the fraudulent activities. However, it can be challenging for the investigators to recognize the different types of fraud occurring as the criminals become better able to obfuscate their actions. Thus, there is a need for improved computer-based fraud detection systems that can provide both automatic fraud analysis and illustrative graphical presentations of transactions flows to overcome the problems discussed above.

### SUMMARY

According to one embodiment, a system includes a non-transitory memory and one or more hardware processors coupled to the non-transitory memory that are configured to read instructions from the non-transitory memory to cause the system to perform operations including receiving, from a plurality of accounts with a service provider, a selection of one or more seed accounts. The operations further include generating a graph based on the one or more seed accounts, where the graph includes a plurality of nodes including one or more first nodes corresponding to the one or more seed accounts and a plurality of second nodes corresponding to a plurality of accounts that are associated with the one or more seed accounts. The operations further include linking related nodes within the graph, where a pair of nodes are related with each other in the graph based on a common attribute shared between a pair of corresponding accounts. The operations further include identifying, within one or more communities in the graph, one or more groups based at least on a density of connections among the nodes within the one or more communities. The operations further include determining, using a machine learning model and for each group in the one or more groups, a corresponding label, where the machine learning model is configured and trained to determine the corresponding label based on one or more group-based features associated with the group. The operations further include performing an action to at least one account corresponding to a particular node in the graph based on a corresponding label determined for a particular group that includes the particular node in the graph.

According to another embodiment, a method includes receiving, from a plurality of accounts with a service provider, a selection of one or more seed accounts. The method further includes generating a graph based on the one or more seed accounts, where the graph comprises one or more seed nodes corresponding to the one or more seed accounts and a plurality of counterparty nodes corresponding to a plurality of counterparty accounts that are counterparties to the one or more seed accounts via a plurality of transactions. The method further includes displaying a presentation of the graph representing the one or more seed accounts and the one or more counterparty accounts and the plurality of transactions. The method further includes linking related nodes within the graph, where a pair of nodes are related with each other based on a common attribute shared between a pair of corresponding accounts. The method further includes determining one or more communities within the graph based on the linked nodes. The method further includes identifying, within the one or more communities in the graph, one or more groups based at least on a density of connections among the nodes within the one or more communities. The method further includes determining, using a machine learning model and for each group in the one or more groups, a corresponding label, where the machine learning model is configured and trained to determine a label based on one or more group-based features associated with the group. The method further includes transforming the presentation of the graph based on the one or more groups and the corresponding labels.

According to another embodiment, a non-transitory machine-readable medium having stored thereon machine-readable instructions executable to cause a machine to perform operations including receiving one or more seed accounts from a plurality of accounts of a service provider. The operations further include identifying a community based on the one or more seed accounts, the community including one or more of the plurality of accounts. The operations further include identifying one or more groups within the community, the one or more groups being based at least on a density of connections between the one or more accounts within the community. The operations further include determining, for each group in the one or more groups, one or more labels where each of the one or more labels is associated with a fraudulent activity. The operations further include generating a visualization of the community for display, the visualization identifying the one or more groups and the one or more labels for each group. The operations further include transforming the display of the visualization based on the one or more groups and the one or more labels.

### BRIEF DESCRIPTION OF THE FIGURES

FIG. 1 is a block diagram illustrating an electronic transaction system according to an embodiment of the present disclosure;

FIG. 2 is a block diagram illustrating an exemplary security system according to an embodiment of the present disclosure;

FIG. 3 illustrates an exemplary community including multiple groups according to an embodiment of the present disclosure;

FIG. 4 illustrates exemplary relationships between senders and receivers of a payment system according to an embodiment of the present disclosure;

FIG. 5 illustrates an exemplary community including one group identified as potentially being associated with fraudulent activity according to an embodiment of the present disclosure;

FIG. 6 illustrates an exemplary community including two groups identified as potentially being associated with fraudulent activity according to an embodiment of the present disclosure;

FIG. 7 is a flowchart showing a process of configuring and training a machine learning system to identify fraudulent activity within a community according to an embodiment of the present disclosure;

FIG. 8 is a flowchart showing a process of identifying potentially fraudulent activity within a community using a machine learning system according to an embodiment of the present disclosure; and

FIG. 9 is a block diagram of a system for implementing a device according to an embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

The present disclosure describes methods and systems for group-based analysis of transactions among accounts and providing an interactive interface for presenting visual illustrations of account transactions according to various embodiments of the disclosure. Current fraud detection systems use existing rules that are based on a single account's transaction behavior. Furthermore, investigators rely on their accumulated experience and knowledge to identify red flags for the potential unknown risks and fraudulent activities. Embodiments of the present disclosure disclose methods and systems using group-based graph analysis, machine learning, and interactive graph visualization to automatically identify suspicious account activity conducted via a payment provider. In particular, the methods and systems disclosed herein improve upon current fraud detection methods by analyzing transactions conducted through related accounts in a collective manner within a graph. By analyzing the transactions conducted through the related accounts as a whole, group attributes that are associated with each group of related transactions can be extracted. The group attributes may not be obtained when the transactions (or transactions conducted through each account) are analyzed individually. However, the group attributes may be indicative of potential fraudulent activities that are conducted among related accounts in concert. Thus, in some embodiments, the group attributes may be provided to a machine learning model that is trained to detect fraudulent transaction patterns based on group attributes.

Such a security system that uses group-based analysis may be effective in detecting various fraudulent activities conducted via payment transactions, such as mass payment transactions. In a typical payment transaction, a single sender sends a payment to a single receiver using a single currency. In contrast, in a mass payment transaction, a single sender sends many payments to many recipients and may use many currencies within a short time period (e.g., a second, five seconds, etc.). For example, a service provider may provide a mass payment tool that enables users of the service provider to initiate mass payment transactions. As such, after setting up the parameters of a mass payment transaction, a user may initiate the multiple payments sent to multiple recipients based on a single user action, instead of performing multiple user actions to send payments to the recipients individually as single payment transactions. In some examples, a single mass payment transaction may involve thousands of recipients and/or payments using multiple different currencies. Thus, the mass payment tool provides benefits to users when they need to perform multiple payment transactions at once. For example, mass payment transactions may be used by a merchant to pay rebates and/or rewards to users, by a live streaming platform to send rebates to viewers, by a business owner to pay commissions to its employees, or by a marketplace provider to send disbursements to its vendors.

However, due to the nature of the mass payment tools, security processes and protocols may not be as robust or effective compared to processing of single transactions. As a result, malicious users may abuse the mass payment tool by using it in malicious (and often illegal) manners. For example, malicious users may use the mass payment tool to conduct money laundering activities where the sender sends many payments to the same users with which the sender is colluding. In such scenarios, the sender may send payments to a large number of recipients in a mass payment transaction to make it look legitimate. However, the sender may concentrate the payments (either by the number of payments or the amounts included in the payments) to only selected few recipients who are in collusion with the sender. Malicious users may also use the mass payment tools to circumvent geofencing restrictions. Existing tools may be inadequate for detecting these types of abuses. For example, using existing tools, each of these payments appears to be legitimate payments of one sender to one recipient and would not be flagged as an abuse of the payment system.

As such, according to various embodiments of the disclosure, a security system may use a group-based analysis to detect potential suspicious activities conducted by users of the service provider based on attributes extracted from a group of accounts that include accounts that are deemed to be related with each other. In some embodiments, the security system may allow investigators to select, from accounts with the payment provider, a set of accounts for fraud detection purpose (e.g., identifiers of the selected accounts may be uploaded as an account list to the security system, etc.). The account list may include one or more accounts. In some embodiments, there are no upper limits to the number of accounts included in the account list. For example, if desired, all accounts with the payment provider may be uploaded to the security system. The accounts received in the accounts list are considered to be seed accounts from which the security system framework can begin working to identify different communities and groups of accounts within the payment system. The seed accounts may be selected automatically by the security system or manually by a user. For example, the security system may automatically select one or more accounts that are suspected of fraudulent and/or malicious behavior to be the seed accounts. This may be determined by analyzing each account on an individual basis. In another example, the security system may randomly select accounts to be seed accounts as a quality control measure. In other examples, a user may select one or more accounts to be seed accounts based on reports or other information.

Using the provided one or more seed accounts, the security system processes historical data representing transactions conducted via the payment provider. The security system may identify accounts that have received one or more payments from the one or more seed accounts (the accounts that receive payments from a seed account are also referred to as “recipient accounts” or “counterparty accounts”). In some embodiments, the security system may generate a graph that represents the one or more seed accounts and the counterparty accounts. The graph may include nodes for representing the seed accounts and the counterparty accounts, and edges that connect a node representing a seed account to a node representing a counterparty account when a payment has been conducted between the seed account and the counterparty account (e.g., the seed account has transmitted a payment, such as a mass payment, to the counterparty account).

Information about each of the counterparty accounts and the one or more seed accounts is analyzed. Accounts that share common attributes (e.g., an address, contact information, credit card number, bank account number, etc.) are linked, and accounts that are linked directly or indirectly with each other may form a distinct community of accounts. Analysis may further include account information including profile information, account restriction history, customer identification program, “know your customer” (KYC), special activity report, and other information within the system. Other linking relationships may include sharing a credit card number, sharing a bank account number, and sharing a name, to name a few.

The security system then forms a linking graph of all of the accounts, both seed and counterparty accounts, based on the linking relationships that are identified. The linking graph may be created using a graph application (e.g., Giraph). The security system may use one or more different algorithms to create the linking graph. For example, an algorithm may link different accounts based on shared account attributes where the number of shared attributes exceeds a threshold. In another example, an algorithm may link different accounts based on a number of payments made between two or more accounts.

As discussed herein, the graph generated by the security system may initially represent the seed accounts, the counterparty accounts, and the transactions conducted between the seed accounts and the counterparty accounts. For example, the graph may include nodes for representing the seed accounts and the counterparty accounts. The graph may also include edges for representing transactions conducted between a seed account and a counterparty account. The security system may then link nodes when the corresponding accounts share at least one common attribute (e.g., an address, a name such as a business name, financial account information, contact information, profile information, etc.). Nodes that are linked directly or indirectly with each other may form a community. For example, a first node may be linked with a second node in the graph because the accounts corresponding to the first and second nodes share a common bank account number. The second node may also be linked to a third node because the accounts corresponding to the second and third nodes share a common business name. The security system may then determine that the first node, the second node, and the third node, representing the first account, the second account, and third account, respectively, belong to the same community within the graph. While the illustrations and discussion herein are directed to mass payment systems, it should be understood that the security system framework may be used with other types of payment systems. Additionally, the security system framework disclosed herein may be used in other applications that are outside of payment systems that include a large number of interconnected actors.

After forming one or more communities based on linking relationships between accounts, the security system may further divide each community into one or more groups based on the linking characteristics among the nodes within the community. A group of accounts may have denser relationships with each other than with other accounts within the community. In some examples, a denser relationship may be determined by links between accounts within the community, where each link is determined by a common attribute that is shared between the linked accounts. In some other examples, a denser relationship may be determined by the number of links between a single account and the other accounts within the community. In other examples, the denser relationship may be determined based on a threshold number of common attributes. Other alternative ways to identify groups within a community are also described in a co-owned U.S. patent application Ser. No. 17/509,854 filed on Oct. 25, 2021 and titled “Graph-Based Multi-Threading Group Detection,” which is incorporated herein by reference in its entirety.

The security system may then extract group features from each of the groups within the communities. Some examples of group-based features may include a group size, an “account bad” rate within a group (e.g., the percentage of accounts within the group that have been identified as participating in fraudulent and/or malicious activities), the linking density of the group, among others. Other considerations include the movement of funds within the group and movement of funds outside of the group. The security system may use this information to identify patterns corresponding to fraudulent activities, risk detection, compliance, etc. conducted by accounts within the group. For example, using the mass payment abuse examples discussed herein, the security system may determine group feature patterns that correspond to a first abuse behavior—a business sending concentrated payments to one or more accounts of a single customer, group feature patterns that correspond to a second abuse behavior—a business sending concentrated payments to one or more accounts of a single business, group feature patterns that correspond to a third abuse behavior (special due diligence categories)—accounts that require additional investigation such as, for example, live streaming and online dating payments, and group feature patterns correspond to a fourth abuse behavior (layering of fraudulent activities)—multiple accounts in a group exhibiting that same fraudulent activity, etc. The security system may detect whether a group of accounts have conducted activities related to any one of the abuse behaviors based on matching the group features extracted from the group to one of the group feature patterns. In some embodiments, the group features extracted from each group may be provided to a machine learning model that is configured and trained to output one or more abuse labels based on the group features.

The security system then applies one or more labels to each group based on the matched group feature pattern(s). Each label identifies one or more abnormal behaviors of the accounts within the group. The labels are determined by a machine learning model. The machine learning model is trained using a dataset of labeled and unlabeled groups based on real transaction data. Each group within the training data may include zero or more labels. After training the machine learning model, the labels that are assigned to a group will be assigned score that indicates the probability that the group has the assigned label.

Additional analysis and/or actions may be performed by the security system based on the labeled groups. For example, additional investigative steps may be triggered based on the group label. In some examples, the special due diligence labels may direct the security system to perform additional investigative steps which may include analysis of downstream payment transactions of one or more accounts in the group, flagging one or more accounts in the group for review by an investigator, and using existing tools to further analyze the payments, to name a few. Further review of account transactions may include analyzing transactions outside of the initial scope of the analysis to identify one or more hops of downstream transactions. In some other examples, the labels may be used to perform different actions to the accounts within the group. Such actions may include reversing one or more payments, stopping one or more payments, and/or suspending one or more accounts, to name a few.

The security system framework then implements an interactive graph visualization allowing investigators to further explore and review any suspicious groups. The interactive graph allows investigators to pick one or more groups to see the linking between the accounts within each group and between the groups. The interactive graph may allow the investigator to see the assigned labels, the score associated with each label, and all account information related to each account with the group. Based on this review, the investigator may decide to change the labels to be more accurate. The changed labels may be fed back to the machine learning model as a feedback mechanism to further improve the performance of the machine learning model.

The systems and methods disclosed herein improve fraud and abnormal behavior detection in any payment system. Specifically, the systems and methods improve detection in payment systems involving high speed, high frequency, and high volume transactions. These improvements are possible because the community and group-based approach to analyzing transaction information enables the security system to detect transaction patterns based on group features that would not have been possible when the accounts and transactions are analyzed individually. The group-based analysis provides a holistic view of the transactions which improves fraud detection, abnormal behavior detection, and money laundering detection, to name a few. Furthermore, the labels assigned to each group provide quick insights to the accounts and suggestions as to which course of action to pursue.

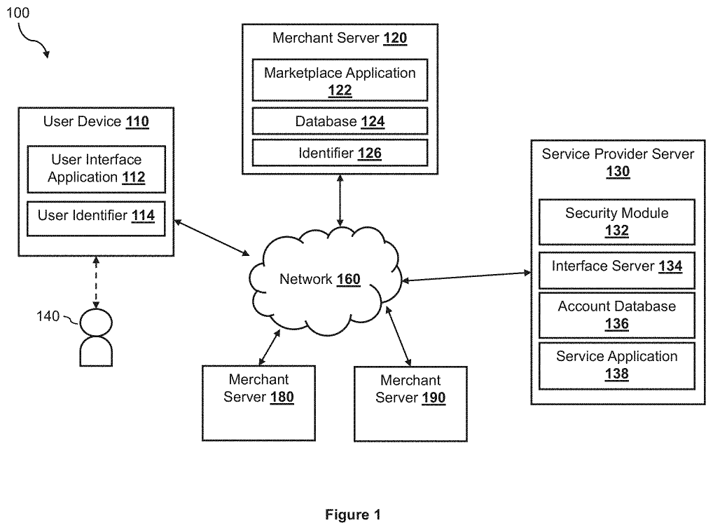

FIG. 1 illustrates an electronic transaction system 100, within which the fraud detection system may be implemented according to one embodiment of the disclosure. The electronic transaction system 100 includes a service provider server 130, merchant servers 120, 180, and 190, and a user device 110 that may be communicatively coupled with each other via a network 160. The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network 160 may comprise a wireless telecommunications network (e.g., cellular phone network) adapted to communicate with other communication networks, such as the Internet.

The user device 110, in one embodiment, may be utilized by a user 140, which may be an individual, a bot, or other computing entity) to interact with any one of the merchant servers 120, 180, and 190, and/or the service provider server 130 over the network 160. For example, the user 140 may use the device 110 to conduct an online purchase transaction with the merchant server 120 via websites hosted by, or mobile applications associated with, the merchant server 120 respectively. The user 140 may also log in to a user account to access account services or conduct electronic transactions (e.g., mass pay transactions or individual transactions, legitimately or fraudulently) with the service provider server 130. The user device 110, in various embodiments, may be implemented using any appropriate combination of hardware and/or software configured for wired and/or wireless communication over the network 160. In various implementations, the user device 110 may include at least one of a wireless cellular phone, wearable computing device, PC, laptop, etc.

The user device 110, in one embodiment, includes a user interface application 112 (e.g., a web browser, a mobile payment application, etc.), which may be utilized by the user 140 to conduct electronic transactions (e.g., online payment transactions, etc.) with any one of the merchant servers 120, 180, and 190, and/or the service provider server 130 over the network 160. In one aspect, purchase expenses may be directly and/or automatically debited from an account related to the user 140 via the user interface application 112.

In one implementation, the user interface application 112 includes a software program (e.g., a mobile application) that provides a graphical user interface (GUI) for the user 140 to interface and communicate with the service provider server 130 and/or any one of the merchant servers 120, 180, and 190 via the network 160. In another implementation, the user interface application 112 includes a browser module that provides a network interface to browse information available over the network 160. For example, the user interface application 112 may be implemented, in part, as a web browser to view information available over the network 160.

The user device 110, in one embodiment, may include at least one user identifier 114, which may be implemented, for example, as operating system registry entries, cookies associated with the user interface application 112, identifiers associated with hardware of the user device 110 (e.g., a media control access (MAC) address), or various other appropriate identifiers. In various implementations, the identifier 114 may be passed with a user login request to the service provider server 130 via the network 160, and the identifier 114 may be used by the service provider server 130 to associate the user with a particular user account (e.g., and a particular profile) maintained by the service provider server 130.

The merchant server 120, in various embodiments, may be maintained by a business entity (or in some cases, by a partner of a business entity that processes transactions on behalf of business entity). Examples of business entities include merchant sites, resource information sites, utility sites, real estate management sites, social networking sites, etc., which offer various items for purchase and process payments for the purchases. The merchant server 120 may include a merchant database 124 for identifying available items, which may be made available to the user device 110 for viewing and purchase by the user 140.

The merchant server 120, in one embodiment, may include a marketplace application 122, which may be configured to provide information over the network 160 to the user interface application 112 of the user device 110. In one embodiment, the marketplace application 122 may include a web server that hosts a merchant web site for the merchant. For example, the user 140 of the user device 110 may interact with the marketplace application 122 through the user interface application 112 over the network 160 to search and view various items available for purchase in the merchant database 124. The merchant server 120, in one embodiment, may include at least one merchant identifier 126, which may be included as part of the one or more items made available for purchase so that, e.g., particular items are associated with the particular merchants. In one implementation, the merchant identifier 126 may include one or more attributes and/or parameters related to the merchant, such as business and banking information. The merchant identifier 126 may include attributes related to the merchant server 120, such as identification information (e.g., a serial number, a location address, GPS coordinates, a network identification number, etc.).

A merchant may also use the merchant server 120 to communicate with the service provider server 130 over the network 160. For example, the merchant may use the merchant server 120 to communicate with the service provider server 130 in the course of various services offered by the service provider to a merchant, such as payment intermediary between customers of the merchant and the merchant itself. For example, the merchant server 120 may use an application programming interface (API) that allows it to offer sale of goods or services in which customers are allowed to make payment through the service provider server 130, while the user 140 may have an account with the service provider server 130 that allows the user 140 to use the service provider server 130 for making payments to merchants that allow use of authentication, authorization, and payment services of the service provider as a payment intermediary. In one example, the marketplace application 122 may include an interface server (e.g., a web server, a mobile application server, etc.) that provides an interface (e.g., a webpage) for the user 140 to interact with the merchant server 120. The merchant web site hosted by the merchant server 120 may include a home webpage, many different product webpages related to different products, which may include webpage elements (e.g., links, selectable elements, etc.) for further configuring the product presented on the webpage and for initiating payment services with the service provider server 130 and possibly other service providers.

Each of the merchant servers 180 and 190 may be associated with a different business entity (e.g., a different merchant site, etc.), and may include similar components as the merchant server 120. As such, each of the merchant servers 180 and 190 may offer products and/or services for sale via a respective user interface (e.g., a respective website, etc.). The user 140 may, via the user interface application 112 of the user device 110, browse through different product pages of the merchant servers 120, 180, and 190, and may initiate a purchase transaction for purchasing any one or more products from the merchant servers 120, 180, and 190.

The service provider server 130, in one embodiment, may be maintained by a transaction processing entity or an online service provider, which may provide processing for electronic transactions between the user 140 of user device 110 and one or more merchants. As such, the service provider server 130 may include a service application 138, which may be adapted to interact with the user device 110 and/or the merchant servers 120, 180, and 190 over the network 160 to facilitate the searching, selection, purchase, payment of items, and/or other services offered by the service provider server 130. In one example, the service provider server 130 may be provided by PayPal®, Inc., of San Jose, Calif., USA, and/or one or more service entities or a respective intermediary that may provide multiple point of sale devices at various locations to facilitate transaction routings between merchants and, for example, service entities.

In some embodiments, the service application 138 may include a payment processing application (not shown) for processing purchases and/or payments for electronic transactions, including mass pay transactions, between a user and a merchant or between any two entities. In one implementation, the payment processing application assists with resolving electronic transactions through validation, delivery, and settlement. As such, the payment processing application settles indebtedness between a user and a merchant, wherein accounts may be directly and/or automatically debited and/or credited of monetary funds in a manner as accepted by the banking industry.

The service provider server 130 may also include an interface server 134 that is configured to serve content (e.g., web content) to users and interact with users. For example, the interface server 134 may include a web server configured to serve web content in response to HTTP requests. In another example, the interface server 134 may include an application server configured to interact with a corresponding application (e.g., a service provider mobile application) installed on the user device 110 via one or more protocols (e.g., RESTAPI, SOAP, etc.). As such, the interface server 134 may include pre-generated electronic content ready to be served to users. For example, the interface server 134 may store a log-in page and is configured to serve the log-in page to users for logging into user accounts of the users to access various service provided by the service provider server 130. The interface server 134 may also include other electronic pages associated with the different services (e.g., electronic transaction services, etc.) offered by the service provider server 130. As a result, a user may access a user account associated with the user and access various services offered by the service provider server 130, by generating HTTP requests directed at the service provider server 130.

The service provider server 130, in one embodiment, may be configured to maintain one or more user accounts and merchant accounts in an account database 136, each of which may be associated with a profile and may include account information associated with one or more individual users (e.g., the user 140 associated with user device 110) and merchants. For example, account information may include private financial information of users and merchants, such as one or more account numbers, passwords, credit card information, banking information, digital wallets used, or other types of financial information, transaction history, Internet Protocol (IP) addresses, device information associated with the user account. In certain embodiments, account information also includes user purchase profile information such as account funding options and payment options associated with the user, payment information, receipts, and other information collected in response to completed funding and/or payment transactions.

In one implementation, a user may have identity attributes stored with the service provider server 130, and the user may have credentials to authenticate or verify identity with the service provider server 130. User attributes may include personal information, banking information and/or funding sources. In various aspects, the user attributes may be passed to the service provider server 130 as part of a login, search, selection, purchase, and/or payment request, and the user attributes may be utilized by the service provider server 130 to associate the user with one or more particular user accounts maintained by the service provider server 130 and used to determine the authenticity of a request from a user device.

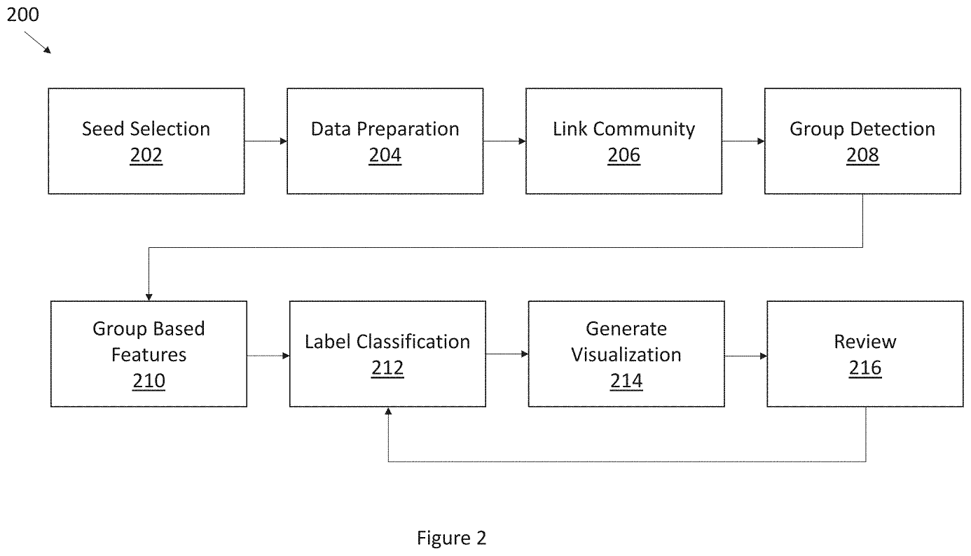

FIG. 2 illustrates a block diagram of an exemplary security system framework 200 that can be implemented by the security module 132 for performing the group-based analysis of payment transactions according to embodiments of the present disclosure. The security system framework 200 includes one or more modules or processes for a seed selection 202, a data preparation 204, a link community 206, a group detection 208, group-based features 210, a label classification 212, a generate visualization 214, and a review 216. The security system framework 200 may be implemented by the service provider server 130 and more specifically by the security module 132. Alternatively, the security system framework 200 may be implemented by the merchant server 120 or another server/subsystem.

At block 202, the security system 200 identifies one or more seed accounts. Users may upload a list of accounts of interest to the security system 200. The list of accounts may include one or more accounts. In some examples, there may be no upper limit to the number of accounts in the list of accounts as the security system 200 may be designed to process large volumes of accounts. Each of the accounts included in the accounts list is a seed account from which additional counterparty accounts may be identified. For example, the security system 200 uses each seed account to identify other accounts that are linked to one of the accounts in the list of accounts based on payment transactions, account information, and/or other available information. In some examples, the security system 200 selects accounts that have been identified as participating in malicious and/or fraudulent activities to be the seed accounts. This determination may be based on account history, individual account analysis, and/or a community analysis including the account. In some other examples, the security system 200 may select all accounts, both sender and recipient, that were active during a specified time period (e.g., one week, two weeks, one month, etc.). In some other examples, the security system 200 may select one or more accounts at random to be the seed accounts for quality control. In yet some other examples, the security system 200 may select the one or more accounts to be seed accounts based on reported behavior.

At block 204, the security system 200 uses the list of accounts acquired at seed selection 202 to prepare data for analysis. In some examples, data analysis may include identifying the account data to be used for linking different accounts and/or determining different group based features of the accounts. Account information may include mass payment transaction information, account profiles, credit card numbers, bank account numbers, account history, “know your customer,” customer identification program, special activity reports, and more. In some examples, data analysis at block 204 may include identifying links between different accounts within the payment system. The accounts may be linked to one another using different criteria. For example, the security system 200 may identify a link between a seed account and another account (e.g., a recipient account) because both accounts share the same credit card number, the same bank account number, the same full name, and/or other information. As another example, the security system 200 may identify a relationship between the different accounts based on a payment from one account to the other. After identifying a link between a first account (e.g., a seed account) and a second account (e.g., a recipient account), the security system 200 may attempt to identify other accounts that are linked to the second account. For example, the second account may be linked to the third account such that the first account is linked to the second account and the second account is linked to the third account. In some examples, the first account may further be linked to the third account.

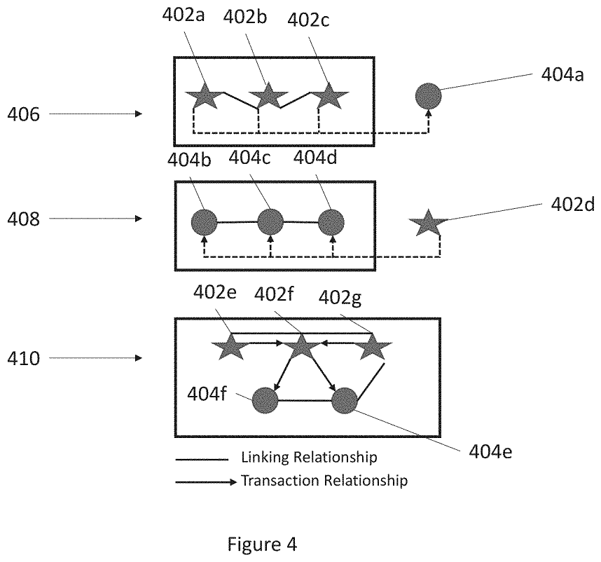

Additional examples are illustrated in FIG. 4. FIG. 4 illustrates sender accounts 402a-g as stars and recipient accounts 404a-f as circles. Linking relationships between the different accounts are illustrated as a straight line and transaction relationships between the different accounts are illustrated with an arrow indicating the direction of the transaction (i.e., the sender to the recipient). Linking relationships are those relationships that are based on common attributes between the accounts (e.g., same credit card number, same bank account number, same name, etc.). Transaction relationships are those relationships that are based on payments made between accounts. Illustrated in FIG. 4 are three examples of linking relationships, specifically a sender only relationship 406, a receiver only relationship 408, and a sender and receiver relationship 410. Each example illustrated in FIG. 4 is simplified for illustration and discussion purposes and is not meant to limit the scope of claimed invention.

In the first example, in the sender only relationship 406, three sender accounts 402a-402c are illustrated alongside one receiver account 404a. Sender account 402a is linked to sender account 402b and sender account 402b is linked to sender account 402c. These links may be identified at the data preparation 204 step by similarities between the accounts 402a-402c as discussed above and are illustrated as lines which may be considered edges. While receiver account 404a is not linked to sender accounts 402a-402c, each of sender accounts 402a-402c has made a payment to receiver account 404a as indicated by the line with the arrow, which may also be considered an edge. That is, sender accounts 402a-402c are linked via linking relationships based on common attributes that are identified between the sender accounts 402a-402c. Additionally, the sender accounts 402a-402c are linked to receiver account 404a based on a transaction relationship that is based on the sender accounts 402a-402c each sending at least one payment to receiver account 404a.

In the second example, in the receiver only relationship 408, three receiver accounts 404b-404d are illustrated alongside one sender account 402d. The three receiver accounts 404b-404d are identified as being linked based on different available data as previously described. In this example, receiver account 404b is linked to receiver account 404c and receiver account 404c is linked to receiver account 404d. Each link, or edge, is represented by a line between each account 404a-404d. Sender account 402d does not have a linking relationship with receiver accounts 404b-404d. However, sender account 402d has a transaction relationship with receiver accounts 404b-404d as indicated by the arrows.

In the third example, in the sender and receiver relationship 410, three sender accounts 402e-402g are illustrated alongside two receiver accounts 404e and 404f. Sender account 402e is linked to sender account 402f, sender account 402f is linked to sender account 402g, sender account 402g is linked to receiver account 404e, and receiver account 404e is linked to receiver account 404f. Additionally, sender account 402e made a payment to sender account 402f, sender account 402g made a payment to sender account 402f, and sender account 402f made a payment to each of receiver accounts 404e and 404f. Each of these links and payments is considered an edge within the group. As illustrated in the third example 410, the relationships between the different accounts can become more complicated as more accounts and more transactions are processed and analyzed.

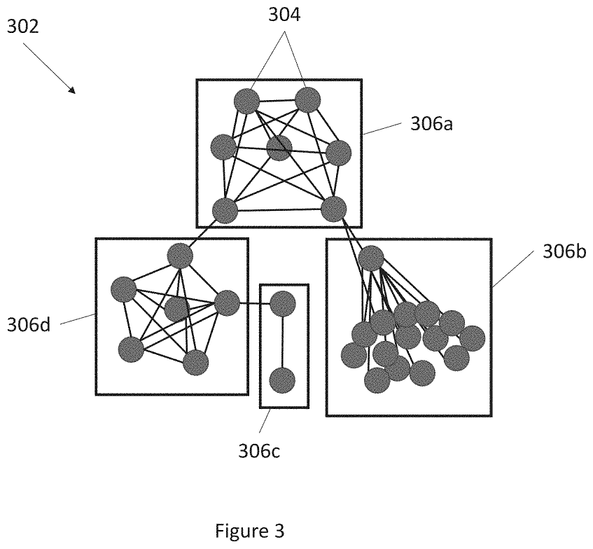

Returning to FIG. 2, at block 206, the security system 200 generates a linking graph of the different accounts and their linking relationships and transaction relationships. The linking graph includes a node for each account and a linking relationship and/or a transaction relationship between two nodes or accounts. The security system 200 may identify one or more communities from a plurality of linked accounts. Each community includes nodes that share links and/or transactions. These links may be represented as edges within a graph. Referring to FIG. 3, illustrated is a community 302 of nodes 304. The different nodes 304 are illustrated as being linked to one another as indicated by the lines, or edges, connecting the different nodes 304.

Returning to FIG. 2, at block 208, the security system 200 identifies one or more groups within each community. Each group within a community includes nodes that are more tightly linked with each other than with the other nodes within the community. As discussed above, there are different ways in which groups may be formed and identified. For example, groups may be formed based on expanding links between seed nodes and linked counterparty nodes to identify a superset of nodes from which to form the group. In some examples, one or more groups may not include a seed node.

Returning to FIG. 3, illustrated is a graph of four groups 306a-306d within the community 302. Each group 306a-306d includes two or more nodes 304 including edges indicating a relationship between the connected nodes. As illustrated in the graph, the links between the nodes of the different groups 306a-306d are tighter than the links with the nodes of the other groups 306a-306d. For example, as illustrated, the nodes 304 of group 306a are tightly linked including each node being linked to multiple other nodes. The nodes 304 of group 306b include one node 304 that is linked to all other nodes 304 within group 306b, each of which is not linked to the other. The nodes 304 of group 306c are linked. Of particular note, group 306c is a group consisting of only two nodes 304 and one link between the two nodes 304. The nodes 304 of group 306d are tightly linked, with each node 304 being linked to multiple nodes 304 with group 306d.

As illustrated, group 306a includes two nodes that are linked to nodes of other groups 306b and 306d. Specifically, one node 304 of group 306a is linked to one node of group 306d and another node of group 306a has two links to nodes in group 306b. As illustrated, there are no links between nodes 304 in group 306a and nodes 304 in group 306c. Additionally, there are no links between nodes 304 in group 306b and nodes in groups 306c and 306d. There is one link between one node in group 306d and one node in group 306c. Accordingly, FIG. 3 is an illustration of an exemplary community 302 including multiple groups 306a-306d according to embodiments of this disclosure that is intended for illustration and discussion purposes only and is not intended to be limiting.

Returning to FIG. 2, at block 210, the security system 200 identifies features within each group (e.g., groups 306a-306d) of the identified communities (e.g., community 302). For example, identified features may be categorized into four types of features such as general graph features, business defined vertex features, intragroup features, and intergroup features, to name a few. These features may provide improved insight into characteristics of the groups and group nodes including how closely the nodes are linked and how payments flow into and out of the groups, among others. In some examples, general graph features of the community and the identified groups within the community may be identified. General graph features may include group size and/or group density to name a few. The group size may include the total number of nodes within the group. The group density may be a number that indicates the density of the connections between the different nodes within the group. For example, looking at FIG. 3, group 306d has a higher group density than group 306b because the nodes of group 306b are linked to a single node without any connection between the other nodes.

Business defined vertex features may include “account bad” rates, “know your customer” (KYC) rates, customer identity program (CIP) rates, suspicious activity report (SAR) rates, and/or account type distributions, to name a few. The different types of rates provide improved understanding of the of the group as a whole based on the nodes within the group. For example, the group “account bad” rate may be a count of the number of nodes that have previously been identified as participating in suspicious and/or fraudulent activity. The KYC rate and the CIP rate each provide an indication of the number of nodes within a group that have been previously verified. A group in which all nodes have been verified through KYC or CIP is less likely to be participating in fraudulent and/or suspicious activities. Similarly, the SAR rate provides a count of the nodes within the group for which a report has been filed for money laundering, fraud, crime, payment system violation, etc. Additional features and attributes may be added to improve the accuracy of detecting suspicious and/or fraudulent activities. Using these features, the system may better determine whether the group or accounts/activities within the group should be investigated further. For example, if multiple nodes within the group have a previous offense and the previous offense is the same among the nodes, then further investigation may be requested. Alternatively, if a single node has a previous offense, or if multiple nodes have different offenses, then further investigation may not be requested.

The next group feature category, intragroup features, may include linking types, linking counts, payment amounts, payment counts, and/or unique recipients, to name a few. These features provide an indication of how the different nodes within the group interact with each other. The linking type may indicate a linking relationship or a transaction relationship. The linking relationship may be based on a similarity between the linked nodes including, for example, same credit card number, same bank account number, and/or the same name, to name a few. The transaction relationship may be based on a payment made between the two nodes, either a payment sent or received. For example, as illustrated in FIGS. 2 and 3, the lines indicate either a linking relationship or a transaction relationship between the nodes. Each line may include one or more links and/or transactions between the two nodes. Additionally, the security system 200 may identify the number of unique payment recipients in one or more transactions. The number of unique recipients may account for multiple nodes being associated with a single recipient. In reviewing these features, the system may identify one or more groups for which further investigation may be requested.

The last group feature category, intergroup features, may include linking types, linking counts, payment amounts, payment counts, and/or unique payment recipients. These features are similar to those described above with respect to intragroup features except that they provide an indication of how nodes within different groups interact. For example, as illustrated in FIG. 3, one node in group 306a is linked with two different nodes within group 306b while a different node in group 306a is linked with a single node in group 306d. The intergroup features identify the attributes and features that define the relationship between these nodes in different groups.

At block 212, the security system 200 assigns one or more labels to each group based on the previously identified group features block 210. The security system 200 analyzes the group features to determine whether to apply a label, and which label to apply, to one or more groups. The security system 200 may use a machine learning model to determine which labels to apply to each group. The machine learning model may be trained using a predefined set of labels. Each label may be associated with a different suspicious and/or fraudulent activity. Examples of potential labels include concentrated business to customer, concentrated business to business, special due diligence category, and layering of fraud and/or acceptable use policy (AUP) activities.

The concentrated business to customer label is used when the machine learning model identifies a large number of payments sent to the same customer or individual. For example, one or more payments may be sent to a set of nodes within the group where each of the nodes has been identified as belonging to the same customer or individual. This determination may be based on the nodes sharing a credit card number, a bank account number, a name, and/or another relevant attribute. In some examples, the payments are made to a foreign account where each recipient node has the same account number. In some examples, the payments are made for the purposes of tax evasion in the domestic country.

The concentrated business to business label is used when the machine learning model identifies a large number of payments sent to the same business. Similar to the concentrated business to customer label, one or more payments may be made to a number of nodes where each of the nodes has been identified as belonging to the same business.

The special due diligence category label is used when the machine learning model identifies group features for which additional review may be requested. Some examples may include payments involving live streaming and online dating, among others. The special due diligence category indicates additional review as there may be legitimate reasons why payments are made to the group of associated accounts.

The layering of fraud and/or AUP activities label is used when the machine learning model identifies group features that indicate that multiple nodes within the group have the same suspicious and/or fraudulent activity or that users are circumventing policies and restrictions using the mass payment system. For example, multiple nodes within the group may have suspicious activity reports (SAR) filed. The SARs may have been filed for the same reason or for different reasons. Multiple nodes having the same suspicious and/or fraudulent activity may be a further indication that the nodes within the group are tightly linked. In some other examples, users may use the mass payment system to circumvent domestic and/or foreign payment policies and restrictions.

A score is associated with each label applied to each group to indicate the probability that the label applies to the group. For example, a group (e.g., group 306a) may have three different labels applied and each label having a corresponding score. The score associated with each label indicates a probability assigned by the machine learning model that the specific label applies to the group. As such, a higher score indicates a higher probability that the label applies to the group. Alternatively, a lower score indicates a lower probability that the label applies to the group. The score may be used during later review to determine the accuracy of the label to the group.

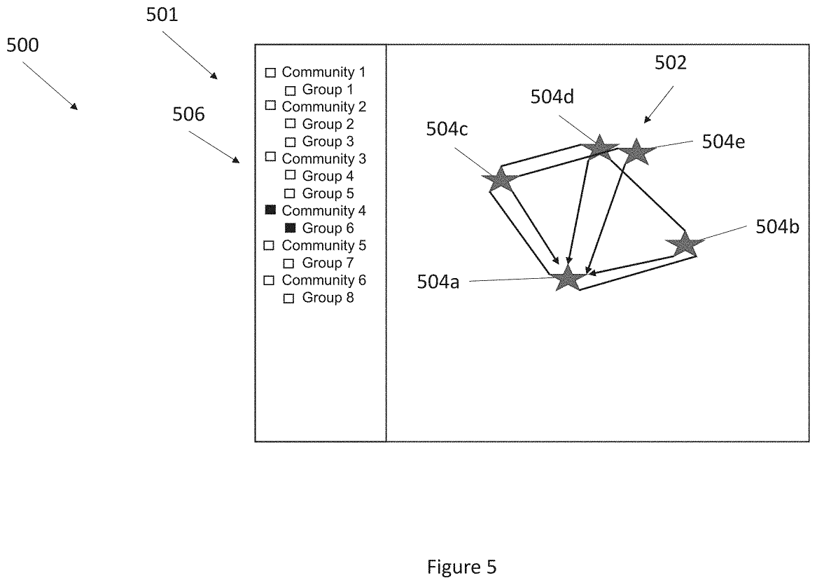

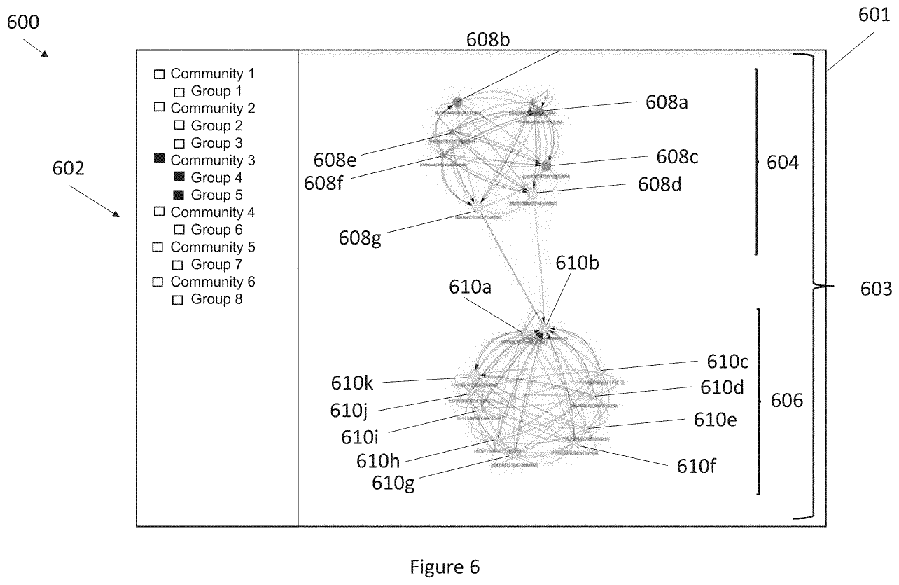

At block 214, the security system 200 generates a visualization of the identified one or more communities and one or more groups. For example, the visualization may be similar to FIGS. 2 and 3 indicating the linking relationships and/or transaction relationships between the different nodes within the community and group(s). Other examples may be seen in FIGS. 5 and 6, described in more detail below. These figures are exemplary illustrations of how a community and group(s) may be displayed and are not intended to be limiting. Additionally, the visualization may provide labels for each node indicating which account each node is associated with. Furthermore, the visualization may show the classification labels and associated scores that were identified by the security system 200. In some examples, the visualization may allow a user to select and view one or more communities and the one or more groups identified within each community.

At block 216, the labels and scores assigned to the groups are reviewed. The review may be performed using the visualization generated at block 214. The labels assigned to each group are reviewed to determine whether or not the label applies to the group. Based on this determination, the security system 200 may send the group for further review and/or action. For example, accounts within the group may be suspended. Additionally, the security system 200 may use the reviewed label and group information to retrain the machine learning model. The reviewed information may be sent to block 212 for retraining the machine learning model in order to improve the accuracy and the performance of the security system 200. Additional actions may also be taken based on the review of the labeled groups. For example, the security system 200 may reverse payments or stop payments to and/or from one or more accounts within the group. The security system 200 may also determine to suspend one or more accounts within the group based on the review.

FIG. 5 illustrates an exemplary user interface that presents a linking graph including nodes that are linked together that form a community. As shown, the community includes at least one group identified as potentially being associated with fraudulent activity according to an embodiment of the present disclosure. In an exemplary use case 500, a user interface 501 displays a community 502 where the community includes nodes 504a-504e. In the use case 500, the community 502 includes a single group that includes all of the nodes 504a-504e in the community 502. In some embodiments, the community 502 and the nodes 504a-504e may be presented using the visualization generated at block 214 described above with respect to FIG. 2. In some embodiments, the visualization may include a selection menu 506 to select which communities and groups to display. In the present example, the selection menu 506 shows that a single community (i.e., community 502) is selected and that the only group within the community 502 is selected.

For the exemplary use case 500, all accounts and transactions over a time period (e.g., March 2020 to March 2021) are analyzed using the security system 200. The security system 200 identified a group of five users, represented as nodes 504a-504e, that are registered in five different regions. In the present example, node 504a represents ABC International Corporation, node 504b represents ABC Country Trading, node 504c represents, Luxury XYZ Company, node 504d represents ABC City Company, and node 504e represents City Trading, LLC. All of these accounts receive payments for selling goods on legitimate websites. As such, each of these accounts would typically not be investigated for fraudulent activity under an individual account based analysis system. However, using the community based analysis, such as that performed by the security system 200, anomalies between the different accounts were identified. For example, after receipt of payment the accounts associated with nodes 504b-504e sent the proceeds of the sales to the account associated with node 504a.

Upon further review, the security system 200 determined that about 35% of the funds received by the account associated with node 504a are withdrawn to a personal credit card and about 15% of the funds received are sent to other accounts as payments. Furthermore, about half of the sent as payments was sent another account, ABC Limited which withdrew the money to company bank accounts. Using the community based approach, the machine learning model of the security system 200 determined that the community 502 and the nodes 504a-504e included abnormal transfer of funds. The abnormal transfers, as described above, included transferring funds from different foreign companies into a single company. The abnormal transfers continue with those funds being split for both personal withdrawals and cross-border asset transfers. However, using the community based approach described herein, the security system 200 correctly identified fraudulent behavior that may have gone unnoticed using conventional fraud detection solutions.

FIG. 6 illustrates an exemplary user interface that presents a linking graph including nodes that are linked together that form a community. As shown, the community includes at least two groups identified as potentially being associated with fraudulent activity according to an embodiment of the present disclosure. In an exemplary use case 600, a user interface 601 displays a selection menu 602, a community 603, a first group 604 within the community 603 nodes 608a-608g, and a second group 606 within the community 603 including nodes 610a-610j. In some embodiments, the community 603, the groups 604, 606, and the nodes 608a-608g, 610a-610k may be presented using the visualization generated at block 214 described above with respect to FIG. 2. In some embodiments, the visualization may include a selection menu 602 that is used to select which communities and groups to display. In the present example, the community 603 and the groups 604, 606 are selected in the selection menu 602. Additionally, the presentation of the user interface 601 may be modified based on the labeling of the groups.

For the exemplary use case 500, all accounts and transactions over a time period (e.g., March 2020 to March 2021) are analyzed using the security system 200. The security system identified a community, community 603, including 19 accounts where each account is represented by one of the nodes 608a-608e, 610a-610k. As illustrated in FIG. 6, each node 608a-608e, 610a-610k includes a label identifying a unique number identifying that node. In some embodiments, that unique number may not be displayed. In the use case 600, the security system 200 identified the nodes 608a-608e, 610a-610k within community 603 as potentially participating in fraudulent activity. The security system 200 determined that the accounts associated with nodes 608a-608g in the group 604 belonged to a single entity, Entity 1, and that the accounts associated with nodes 610a-610k in the group 606 belonged to single entity, Entity 2. Additionally, the security system 200 determined that node 608d in group 604 and node 610b in group 606 share the same bank account.

After further review, the security system 200 determined that both groups 604 and 606 are involved in the same suspicious activities. Specifically, the accounts identified by groups 604 and 606 were pretending to be online sellers offering an assortment items for sale. However, the majority of the items sold were for unbranded shoes with even dollar amounts. The security system 200 identified that the buyers made multiple purchases from different sellers within the same group and paid only with gift cards. Furthermore, the same shipping addresses were observed for different buyers within the group to which fake tracking provided. It appeared that the groups 604 and 606 did not have real business but forged transactions to extract funds from gift cards of which the original funding source was dubiously obscured. The transactions identified by the security system 200 were used by the sellers to transfer the money within the groups 604 and 606 for subsequent withdrawal.

The security system 200 was able to provide improved insight into the actions of the accounts associated with nodes 608a-608g and 610a-610k over current methods and techniques. The community based approach combined with the graphing facilitated an improved investigation and avoided potential operational risks. These improvements are made possible through the use of the machine learning model used by the security system 200 as well as the community based approach disclosed herein.

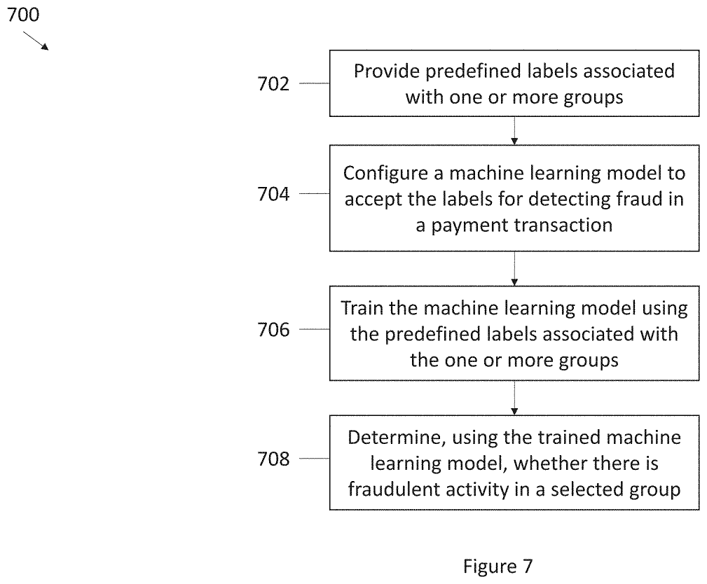

FIG. 7 is a flowchart showing a method 700 of configuring and training a machine learning system to identify fraudulent activity within a community according to an embodiment of the present disclosure, where details of the blocks are further found in the above descriptions. In some embodiments, the method 700 may be performed by the security system 200 that is described above with respect to FIGS. 1 and 2. In some other embodiments, the method 700 may be performed by the service provider server 130.

At block 702, the security system 200 provides predefined labels associated with one or more groups. The predefined labels may include one or more of the labels and label categories described above with respect to FIG. 2. The predefined labels may be provided as a training set to be used to train the machine learning system.

At block 704, the security system 200 configures the machine learning model to accept the labels for detecting fraud in a payment transaction. The security system 200 may configure the machine learning model to accept one or more groups and one or more labels as inputs.

At block 706, the security system 200 trains the machine learning model using the predefined labels associated with the one or more groups. The training data set may include groups that are labeled and groups that are unlabeled. Each of the labeled groups within the training dataset may include one or more labels.

At block 708, the security system 200 uses the trained machine learning model to determine whether there is fraudulent activity within a selected group. After training is completed, the security system 200 may use the machine learning model to assign labels to each of the identified groups. Each group that is assigned a label may be assigned one or more labels. Additionally, a score is assigned to each label to indicate the probability that the label applies to the group.

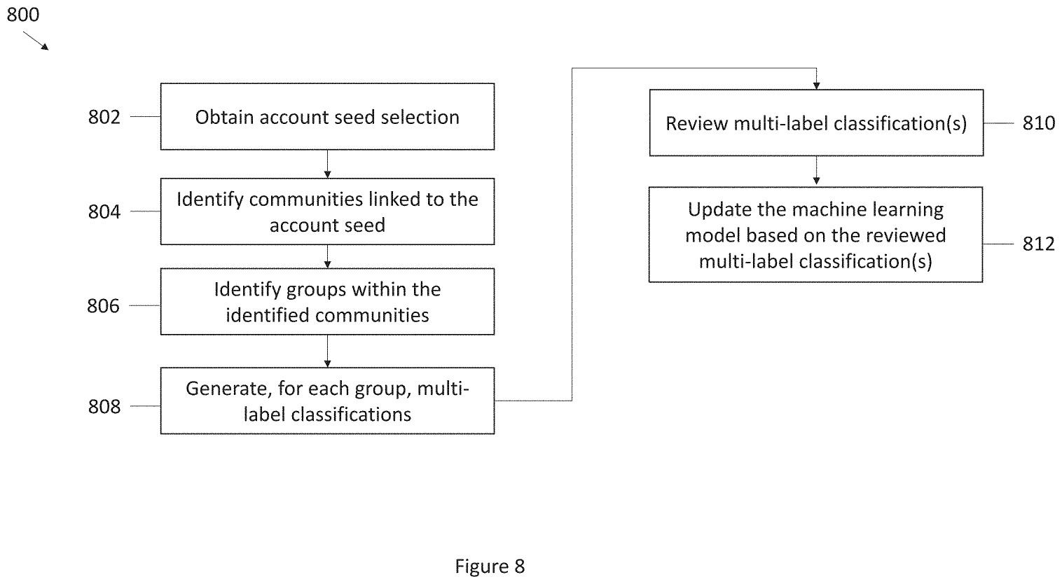

FIG. 8 is a flowchart showing a method 800 of identifying potentially fraudulent activity within a community using a machine learning system according to an embodiment of the present disclosure, where details of the blocks are further found in the above descriptions. The method 800 may be performed by the security system 200 that is described above with respect to FIGS. 1 and 2.

At block 802, the security system 200 obtains seed accounts for processing. Users may upload a list of accounts of interest to the security system 200. The list of accounts may include one or more accounts. In some examples, there may be no upper limit to the number of accounts in the list of accounts as the security system 200 may be designed to process large volumes of accounts. Each of the accounts included in the accounts list is a seed account. The security system 200 uses each seed account to identify other accounts that are linked to one of the accounts in the list of accounts.

At block 804, the security system 200 identifies communities of accounts where each account is linked to one or more of the seed accounts. This includes identifying links between different accounts within a payment system. The accounts may be linked to one another using different criteria. For example, the security system 200 may identify a link between a seed account and another account (e.g., a recipient account) because both accounts share the same credit card number, the same bank account number, the same full name, and/or other information. As another example, the security system 200 may identify a relationship between the different accounts based on a payment from one account to the other. After identifying a link between a first account (e.g., a seed account) and a second account (e.g., a recipient account), the security system 200 may attempt to identify other accounts that are linked to the second account. For example, the second account may be linked to the third account such that the first account is linked to the second account and the second account is linked to the third account. In some examples, the first account may further be linked to the third account.

Additionally, the security system 200 may generate a linking graph of the different accounts and their linking relationships and transaction relationships. The linking graph includes a node for each account and a linking relationship and/or a transaction relationship between two nodes, or accounts. The security system 200 identifies one or more communities within a plurality of linked accounts. Each community includes nodes that share links and/or transactions.

At block 806, the security system 200 identifies groups within the identified communities. Each group within a community includes nodes that are more tightly linked with each other than with the other nodes within the community. As discussed above, there are different ways in which groups may be formed and identified. For example, as illustrated in FIG. 3, there are four groups 306a-306d within the community 302. Each group 306a-306d includes two or more nodes 304. As illustrated, the links between the nodes of the different groups 306a-306d are tighter than the links with the nodes of the other groups 306a-306d. For example, as illustrated, the nodes 304 of group 306a are tightly linked including each node being linked to multiple other nodes. The nodes 304 of group 306b include one node 304 that is linked to all other nodes 304 within group 306b, each of which is not linked to the other. The nodes 304 of group 306c are linked. Of particular note, group 306c is a group consisting of only two nodes 304 and one link between the two nodes 304. The nodes 304 of group 306d are tightly linked with each node 304 being linked to multiple nodes 304 with group 306d.

At block 808, the security system 200 generates one or more labels for each identified group. This may include identifying features of each group and making a label determination based on the features of the group. For example, as described above with respect to block 210 of FIG. 2, identified features may be categorized into four types of features such as general graph features, business defined vertex features, intragroup features, and intergroup features, to name a few. These features may provide improved insight into characteristics of the groups and group nodes including how closely the nodes are linked and how payments flow into and out of the groups, among others.

The security system 200 may then assign one or more labels to each group based on the identified group features. The security system 200 analyzes the group features to determine whether to apply a label, and which label to apply, to one or more groups. The security system 200 may use a machine learning model to determine which labels to apply to each group. The machine learning model may be trained using a predefined set of labels, as described with respect to FIG. 7. Each label may be associated with a different suspicious and/or fraudulent activity. Examples of potential labels include concentrated business to customer, concentrated business to business, special due diligence category, and layering of fraud and/or AUP activities.

In some embodiments, the security system 200 may assign a score to each label assigned to each group. The score may be an indicator of the probability that the label is accurate. Accordingly, a higher score may be an indicator that the machine learning model determined that there is a high probability that the label is accurate. Conversely, a lower score may be an indicator that of a lower probability that the label is accurate.

At block 810, the security system 200 reviews the one or more labels assigned to each group at block 808. The review may be performed using the visualization generated by the security system 200, such as describe above with respect to block 214 in FIG. 2. The labels assigned to each group are reviewed to determine whether or not the label applies to the group. Based on this determination, the security system 200 may send the group for further review and/or action. For example, accounts within the group may be suspended. Additionally, the security system 200 may use the reviewed label and group information to retrain the machine learning model. The reviewed information may be sent to block 212 for retraining the machine learning model in order to improve the accuracy and the performance of the security system 200.

At block 812, the security system 200 may update the machine learning model based on the reviewed labels. After reviewing the labels for accuracy, the results may be provided to the machine learning model as inputs to retrain the machine learning model. Retraining the machine learning model using reviewed labels and groups improves the accuracy of the machine learning model, and therefore the security system 200.

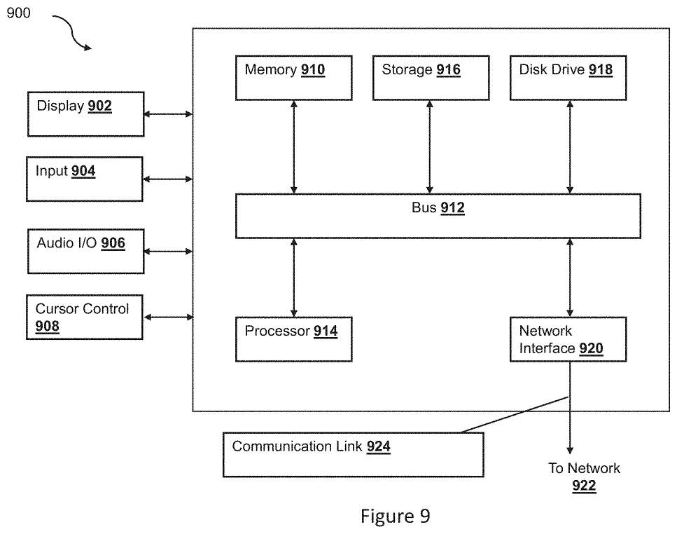

FIG. 9 is a block diagram of a computer system 900 suitable for implementing one or more embodiments of the present disclosure, including the service provider server 130, the merchant servers 120, 180, and 190, and the user device 110. In various implementations, the user device 110 may include a mobile cellular phone, personal computer (PC), laptop, wearable computing device, etc. adapted for wireless communication, and each of the service provider server 130 and the merchant servers 120, 180, and 190 may include a network computing device, such as a server. Thus, it should be appreciated that the devices 110, 120, 130, 180, and 190 may be implemented as the computer system 900 in a manner as follows.

The computer system 900 includes a bus 912 or other communication mechanism for communicating information data, signals, and information between various components of the computer system 900. The components include an input/output (I/O) component 904 that processes a user (i.e., sender, recipient, service provider) action, such as selecting keys from a keypad/keyboard, selecting one or more buttons or links, etc., and sends a corresponding signal to the bus 912. The I/O component 904 may also include an output component, such as a display 902 and a cursor control 908 (such as a keyboard, keypad, mouse, etc.). The display 902 may be configured to present a login page for logging into a user account or a checkout page for purchasing an item from a merchant. An optional audio input/output component 906 may also be included to allow a user to use voice for inputting information by converting audio signals. The audio I/O component 906 may allow the user to hear audio. A transceiver or network interface 920 transmits and receives signals between the computer system 900 and other devices, such as another user device, a merchant server, or a service provider server via network 922. In one embodiment, the transmission is wireless, although other transmission mediums and methods may also be suitable. A processor 914, which can be a micro-controller, digital signal processor (DSP), or other processing component, processes these various signals, such as for display on the computer system 900 or transmission to other devices via a communication link 924. The processor 914 may also control transmission of information, such as cookies or IP addresses, to other devices.

The components of the computer system 900 also include a system memory component 910 (e.g., RAM), a static storage component 916 (e.g., ROM), and/or a disk drive 918 (e.g., a solid-state drive, a hard drive). The computer system 900 performs specific operations by the processor 914 and other components by executing one or more sequences of instructions contained in the system memory component 910. For example, the processor 914 can perform the security system functionalities described herein according to the processes 700 and 800.

Logic may be encoded in a computer readable medium, which may refer to any medium that participates in providing instructions to the processor 914 for execution. Such a medium may take many forms, including but not limited to, non-volatile media, volatile media, and transmission media. In various implementations, non-volatile media includes optical or magnetic disks, volatile media includes dynamic memory, such as the system memory component 910, and transmission media includes coaxial cables, copper wire, and fiber optics, including wires that comprise the bus 912. In one embodiment, the logic is encoded in non-transitory computer readable medium. In one example, transmission media may take the form of acoustic or light waves, such as those generated during radio wave, optical, and infrared data communications.

Some common forms of computer readable media include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by the computer system 900. In various other embodiments of the present disclosure, a plurality of computer systems 900 coupled by the communication link 924 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising steps described herein, and methods performed by one or more devices, such as a hardware processor, user device, server, and other devices described herein.

What is claimed is:

1. A system comprising:
a non-transitory memory; and
one or more hardware processors coupled to the non-transitory memory and configured to read instructions from the non-transitory memory to cause the system to perform operations comprising:
receiving, from a plurality of accounts with a service provider, a selection of one or more seed accounts;
generating a graph based on the one or more seed accounts, wherein the graph comprises a plurality of nodes including one or more first nodes corresponding to the one or more seed accounts and a plurality of second nodes corresponding to a plurality of accounts that are associated with the one or more seed accounts;
linking related nodes within the graph, wherein a pair of nodes are related with each other in the graph based on a common attribute shared between a pair of corresponding accounts;
identifying, within one or more communities in the graph, one or more groups based at least on a density of connections among the nodes within the one or more communities;
determining, using a machine learning model and for each group in the one or more groups, a corresponding label, wherein the machine learning model is configured and trained to determine the corresponding label based on one or more group-based features associated with the group; and
performing an action to at least one account corresponding to a particular node in the graph based on a corresponding label determined for a particular group that includes the particular node in the graph.

2. The system of claim 1, wherein the operations further comprise:
configuring the machine learning model to accept the one or more group-based features as input values; and
training the machine learning model using historical account information.

3. The system of claim 1, wherein the operations further comprise:
generating a presentation of the graph prior to receiving the selection; and
modifying the presentation of the graph based on the one or more groups and the corresponding labels.

4. The system of claim 1, wherein the one or more group-based features comprises at least one of a group size, a group bad rate, or a group density.

5. The system of claim 1, wherein the operations further comprise:
determining, using the machine learning model for a particular group in the one or more groups, a plurality of scores corresponding to a plurality of labels, wherein each label in the plurality of labels represents a fraudulent activity, and wherein each score in the plurality of scores represents a probability that the particular group is involved in a fraudulent activity represented by the corresponding label.

6. The system of claim 1, wherein the operations further comprise:
determining the one or more communities within the graph based on the linked nodes, wherein each community in the one or more communities comprises nodes that are linked with each other.

7. The system of claim 1, wherein the performing the action to the at least one account comprises:
suspending the at least one account.

8. The system of claim 1, wherein at least one group of the one or more groups includes a first node that is linked to a first seed node and a second node that is linked to a second seed node.

9. A method comprising:
receiving, from a plurality of accounts with a service provider, a selection of one or more seed accounts;
generating a graph based on the one or more seed accounts, wherein the graph comprises one or more seed nodes corresponding to the one or more seed accounts and a plurality of counterparty nodes corresponding to a plurality of counterparty accounts that are counterparties to the one or more seed accounts via a plurality of transactions;
displaying a presentation of the graph representing the one or more seed accounts and the one or more counterparty accounts and the plurality of transactions;
linking related nodes within the graph, wherein a pair of nodes are related with each other based on a common attribute shared between a pair of corresponding accounts;
determining one or more communities within the graph based on the linked nodes;
identifying, within the one or more communities in the graph, one or more groups based at least on a density of connections among the nodes within the one or more communities;
determining, using a machine learning model and for each group in the one or more groups, a corresponding label, wherein the machine learning model is configured and trained to determine a label based on one or more group-based features associated with the group; and
transforming the presentation of the graph based on the one or more groups and the corresponding labels.

10. The method of claim 9, further comprising:
configuring the machine learning model to accept the one or more groups and the corresponding labels as input values; and
retraining the machine learning model using the one or more groups and the corresponding labels.

11. The method of claim 9, wherein the common attribute shared between a pair of corresponding accounts is one of a same credit card number, a same bank account number, and a same name.

12. The method of claim 9, further comprising:
linking nodes based on transactions occurring between the nodes.

13. The method of claim 12, the displaying a presentation of the graph further includes displaying a representation of the links between related nodes based on a common attribute and a representation of links between nodes based on the transaction occurring between the nodes.

14. The method of claim 9, wherein at least one group of the one or more groups includes a first node that is linked to a first seed node and a second node that is linked to a second seed node.

15. The method of claim 9, further comprising:
determining, using the machine learning model, a score for each corresponding label, wherein each corresponding label identifies a fraudulent activity, and wherein the score represents a probability that the fraudulent activity is performed within the group assigned the label.

16. The method of claim 15, wherein the presentation of the graph further includes the score determined for each corresponding label.

17. A non-transitory machine-readable medium having stored thereon machine-readable instructions executable to cause a machine to perform operations comprising:
receiving one or more seed accounts from a plurality of accounts of a service provider;
identifying a community based on the one or more seed accounts, the community including one or more of the plurality of accounts;
identifying one or more groups within the community, the one or more groups being based at least on a density of connections between the one or more accounts within the community;
determining, for each group in the one or more groups, one or more labels where each of the one or more labels is associated with a fraudulent activity;
generating a visualization of the community for display, the visualization identifying the one or more groups and the one or more labels for each group; and
transforming the display of the visualization based on the one or more groups and the one or more labels.

18. The non-transitory machine-readable medium of claim 17, wherein the operations further comprise:
determining, for each determined label, a score representing a probability that the fraudulent activity is occurring.

19. The non-transitory machine-readable medium of claim 17, wherein the operations further comprise:
generating a graph based on the one or more of the plurality of accounts within the community; and
displaying a presentation of the graph.

20. The non-transitory machine-readable medium of claim 17, wherein at least one group of the one or more groups includes a first node that is linked to a first seed node and a second node that is linked to a second seed node.
